(19) United States
(12) Patent Application Publication
(10) Pub. No.: US 2014/0354814 A1
(43) Pub. Date: Dec. 4, 2014

(54) Pop-Up Type Camera Module for Vehicle and Method of Controlling Appearance and Disappearance of the Camera Module

(71) Applicants: Sangyeal Han, Seoul (KR); Bumsig Cho, Seoul (KR); Daeseung Kim, Seoul (KR); Seungho Lee, Seoul (KR)

(72) Inventors: Sangyeal Han, Seoul (KR); Bumsig Cho, Seoul (KR); Daeseung Kim, Seoul (KR); Seungho Lee, Seoul (KR)

(73) Assignee: LG INNOTEK CO., LTD., Seoul (KR)

(21) Appl. No.: 14/357,116

(22) PCT Filed: Jun. 26, 2012
(86) PCT No.: PCT/KR2012/005019

§ 371 Date: Aug. 20, 2014

(30) Foreign Application Priority Data
Nov. 8, 2011 (KR) 10-2011-0116002

(51) Int. Cl. B60R 11/04

(52) U.S. Cl. CPC B60R 11/04
USPC 348/148

(57) ABSTRACT

A pop-up type vehicle camera unit according to the present invention includes a camera module; a cover member installed in the rear of the camera module and configured to protect the camera module; a driving motor configured to have one end coupled to the cover member and to rotate the cover member while operating in conjunction with forward rotation and backward rotation operations; and a control unit configured to detect a power source supplied to the camera module, forward rotate the driving motor so that the camera module pops up when the power source supplied to the camera module is turned on, and backward rotates the driving motor so that the camera module is hidden when the power source supplied to the camera module is turned off, wherein the pop-up type camera unit is installed at least one of a front grill and a rear garnish of the vehicle.

### TECHNICAL FIELD

The present invention relates to a camera module used in a vehicle and a method of controlling the appearance and disappearance of the camera module.

### BACKGROUND ART

A camera module for capturing an image is recently being used a lot under the influence of a high degree and automation of vehicle parts. A typical example is front and rear monitoring cameras and a camera module used in a black box, etc.

As an example of the camera module for a vehicle, Korean Patent Laid-Open Publication No. 2009-0083990 (Aug. 5, 2009) discloses a front camera system for capturing an image of a blind spot area that does not come within the range of a driver when the driver drives a car and displaying the captured image on a monitor installed within the car through a multimedia H/U.

In the prior art document, withdrawal and receipt control means is further installed in a front camera module for capturing an image of a blind spot area that does not directly come within the range of a driver. When the engine is not started, the front camera module is received within a radiator grill. When the engine is started or the vehicle is operated at a set speed or lower, the front camera module is turned on and, at the same time, the withdrawal and receipt control means is actuated to draw the front camera module toward the front of the radiator grill. The front camera module captures an image of the blind spot area and displays the captured image on the monitor so that the driver can secure a visual field at the early stage of driving. If the startup of the vehicle is turned off or the vehicle is operated at a set speed or higher, the front camera module is turned off and, at the same time, the withdrawal and receipt control means is reversely operated so that the front camera module is received within the radiator grill. Accordingly, when the vehicle is operated, the front camera module may be prevented from being damaged owing to a collision against an external object.

The front camera system constructed as above, however, is problematic in that the camera may be unnecessarily protruded when the camera is not actually used because the camera is protruded by detecting the driving speed of the vehicle, whether the gears have been changed, etc. while the engine is started. In particular, the camera is chiefly used in special conditions, such as parking and low-speed driving. Accordingly, there is a problem in that the exposure of the camera based on the detection of the speed and the detection of changed gears does not help protect the camera module.

Furthermore, motion conversion means for converting the rotary movement of power generation means into straight-line movement using a motor, screws, etc. is necessary in order to externally protrude the camera module. Accordingly, there are problems in that the structure is complicated and an assembly property due to an increased number of parts is deteriorated.

### DISCLOSURE OF INVENTION

### Technical Problem

An object of the present invention is to provide a pop-up type camera unit for a vehicle having an improved structure, wherein a camera module is protruded outside the vehicle only when the camera module is operated.

### Solution to Problem

A pop-up type vehicle camera unit according to an aspect of the present invention includes a camera module; a cover member installed in the rear of the camera module and configured to protect the camera module; a driving motor configured to have one end coupled to the cover member and to rotate the cover member while operating in conjunction with forward rotation and backward rotation operations; and a control unit configured to detect a power source supplied to the camera module, forward rotate the driving motor so that the camera module pops up when the power source supplied to the camera module is turned on, and backward rotates the driving motor so that the camera module is hidden when the power source supplied to the camera module is turned off, wherein the pop-up type camera unit is installed at least one of a front grill and a rear garnish of the vehicle.

The cover member further includes a rotary movement hinge at one end thereof. It is preferred that the driving motor rotate forward and backward the cover member by rotating the rotary movement hinge.

The driving motor may be directly coupled to the rotary movement hinge and may be indirectly coupled to the rotary movement hinge through a power transfer unit.

Furthermore, the camera module, the cover member, and the driving motor may be integrally configured.

A method of controlling an appearance and disappearance of a camera module for a vehicle according to an aspect of the present invention includes the steps of turning on a battery power source; a control unit determining whether the camera module is operated by detecting a power source supplied to the camera module; determining whether the camera module has popped up if it is determined that the camera module is operated; forward rotating a driving motor so that the camera module is protruded if it is determined that the camera module has not popped up; determining whether the camera module is operated again if it is determined that the camera module has popped up; and backward rotating the driving motor so that the camera module is hidden if it is determined that the camera module is not operated.

### Advantageous Effects of Invention

In accordance with the present invention, damage to the camera module can be minimized because the camera module is protruded outside a vehicle only when the camera module is operated.

### BRIEF DESCRIPTION OF DRAWINGS

FIG. 1 is a schematic diagram of a vehicle including a camera module according to an exemplary embodiment of the present invention;

FIGS. 2 and 3 are schematic diagrams showing the operation state of a pop-up type front camera unit installed in the front part of FIG. 1;

FIGS. 4 and 5 are schematic diagrams showing the operation state of a pop-up type rear camera unit installed in the rear part of FIGS. 1; and

FIG. 6 is a flowchart schematically illustrating a method of controlling the appearance and disappearance of a camera module for a vehicle according to an exemplary embodiment of the present invention.

### BEST MODE FOR CARRYING OUT THE INVENTION

Exemplary embodiments of the present invention are described below with reference to the accompanying drawings.

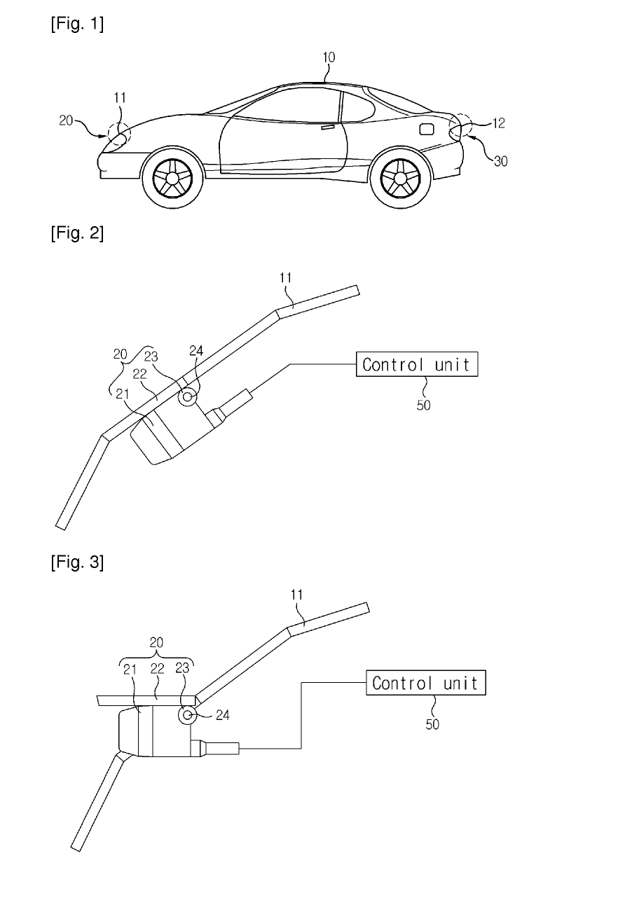

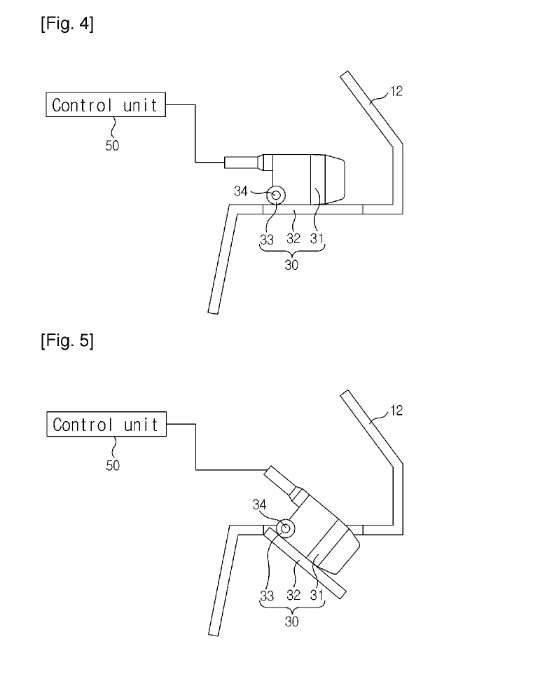

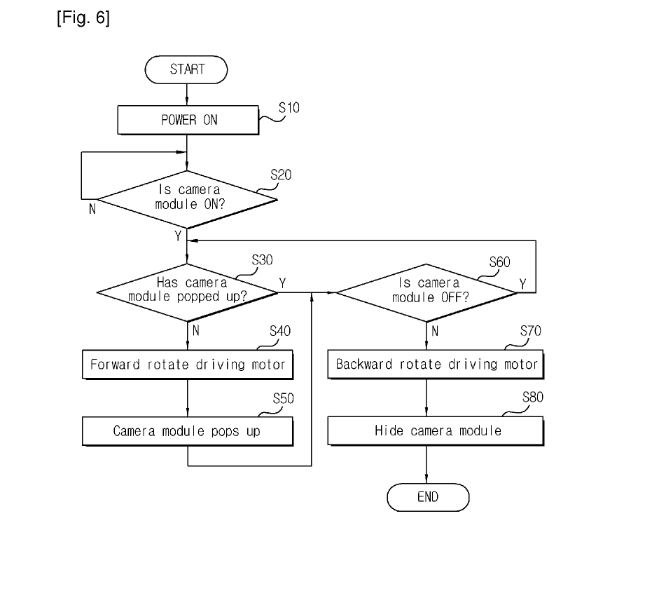

FIG. 1 is a schematic diagram of a vehicle including a camera module according to an exemplary embodiment of the present invention, FIGS. 2 and 3 are schematic diagrams showing the operation state of a pop-up type front camera unit installed in the front part of FIG. 1, FIGS. 4 and 5 are schematic diagrams showing the operation state of a pop-up type rear camera unit installed in the rear part of FIG. 1, and FIG. 6 is a flowchart schematically illustrating a method of controlling the appearance and disappearance of a camera module for a vehicle according to an exemplary embodiment of the present invention.

As shown in FIG. 1, a grill 11 having an air suction port provided therein is provided in the front of a vehicle body 10. A rear garnish 12 in which an emblem for the vehicle or a handle for opening a trunk is installed is provided in the rear of the vehicle body 10.

Various devices for improving user convenience are recently being installed in a vehicle. A camera module for the vehicle captures an image of a blind spot area that does not come within the range of a driver and provides the image information to a driver through a monitor installed within the vehicle.

The pop-up type camera unit may include a pop-up type front camera unit 20 for photographing the front of the vehicle and a pop-up type rear camera unit 30 for photographing the rear of the vehicle. The front camera unit 20 and the rear camera unit 30 may be configured to have the same construction and may be configured to have different resolutions as occasion demands.

The front camera unit 20 includes a front camera module 21, a first cover member 22, and a first driving motor 23.

The front camera module 21 is equipped with an image sensor and an automatic focus control device and configured to capture a front image of the vehicle. The front camera module 21 may be provided as occasion demands in order to photograph not only the front, but also the blind spot areas of the left and the right. For example, the front camera module 21 for the front and the front camera modules 21 for the left and the right may be assembled and configured in one frame.

The first cover member 22 is installed at the bottom surface of the front camera module 21 and may be equipped with a first rotary movement hinge 24 so that the first rotary movement hinge 24 is rotatably moved and opened and shut at the end of one side of the first cover member 22. The first rotary movement hinge 24 is hinged and coupled to the grill 11, so that the first cover member 22 is rotatably coupled to the grill 11.

The first driving motor 23, as shown in FIGS. 2 and 3, may be integrally installed with the front camera module 21 coupled to the first cover member 22. The first driving motor 23 may be configured in various ways. If, as shown, the output axes of the first rotary movement hinge 24 and the first driving motor 23 are installed on the same axis so that the first rotary movement hinge 24 is rotated while operating in conjunction with the rotation of the first driving motor 23, however, the first cover member 22 can be rotated while operating in conjunction with the rotation of the first driving motor 23 because the first rotary movement hinge 24 is also integrally formed with the first cover member 22.

Meanwhile, the first driving motor 23 is controlled so that it is rotated forward or backward in response to the control signal of a control unit 50. For example, when the first driving motor 23 is forward rotated, the front camera module 21 may pop up and protrude outside the grill 11. When the first driving motor 23 is backward rotated, the front camera module 21 may return to a receipt state (i.e., the first state).

Whether the front camera module 21 is supplied with a power source and is in the operating state is determined based on the control signal of the control unit 50. That is, when the front camera module 21 is supplied with the power source and in the operating state, the control unit 50 detects the operating state and forward rotates the first driving motor 23 so that the front camera module 21 externally pops up. However, when the front camera module 21 is not in the operating state, the control unit 50 backward rotates the first driving motor 23 in order to receive the front camera module 21 that has popped up.

In accordance with the above construction, the front camera module 21 is externally exposed only when it is used. Accordingly, the lens of the front camera module 21 can be prevented from being contaminated by a contaminant or damage to the front camera module 21 due to a collision against with an external object, such as a stone, can be prevented when the front camera module 21 is always externally exposed.

Meanwhile, as shown in FIGS. 4 and 5, the same construction may be provided in the rear of the vehicle.

More specifically, the rear camera unit 30 includes a rear camera module 31, a second cover member 32, and a second driving motor 33.

The rear camera module 31 is equipped with an image sensor and an automatic focus control device and configured to capture a rear image of the vehicle. The rear camera module 31 may be provided as occasion demands in order to photograph not only the rear, but also the blind spot areas of the left and the right. For example, the rear camera module 31 for the rear and the image sensors and the rear camera modules 31 for the left and the right may be assembled and configured in one frame. The rear camera module 31 may have the same specification as the front camera module 21 or may have a different resolution from the front camera module 21 as occasion demands.

The second cover member 32 is installed at the bottom surface of the rear camera module 31 and may be equipped with a second rotary movement hinge 34 so that the second rotary movement hinge 34 is rotatably moved and opened and shut at the end of one side of the second cover member 32. The second rotary movement hinge 34 is hinged and coupled to a rear garnish 12 provided in the rear of the vehicle, so that the second cover member 32 may be rotatably coupled to the rear garnish 12.

The second driving motor 33, as shown in FIGS. 4 and 5, may be integrally installed with the rear camera module 31 to which the second cover member 32 is coupled. The second driving motor 33 may be configured in various ways. If, as shown, the output axes of the second rotary movement hinge 34 and the second driving motor 33 are installed on the same axis so that the second rotary movement hinge 34 is rotated while operating in conjunction with the rotation of the second driving motor 33, however, the second cover member 32 can be rotated while operating in conjunction with the rotation of the second driving motor 33 because the second rotary movement hinge 34 is also integrally formed with the second cover member 32.

Meanwhile, the second driving motor 33 is controlled so that it is rotated forward or backward in response to the control signal of the control unit 50. For example, when the second driving motor 33 is forward rotated, the rear camera module 31 may pop up and protrude outside the rear garnish 12. When the second driving motor 33 is backward rotated, the rear camera module 31 may return to a receipt state (i.e., the first state).

Whether the rear camera module 31 is supplied with a power source and is in the operating state is determined based on the control signal of the control unit 50. That is, when the rear camera module 31 is supplied with the power source and in the operating state, the control unit 50 detects the operating state and forward rotates the second driving motor 33 so that the rear camera module 31 externally pops up. However, when the rear camera module 31 is not in the operating state, the control unit 50 backward rotates the second driving motor 33 in order to receive the rear camera module 31 that has popped up.

Meanwhile, although not shown, the first driving motor 23 may be coaxially installed with the first rotary movement hinge 24 so that motive power is not directly transferred, but may be transferred through power transfer means. The same principle applies to the second driving motor 33 and the second rotary movement hinge 34.

Furthermore, it is preferred that the front camera module 21, the first cover member 22, and the first driving motor 23 be integrated into one module and the rear camera module 31, the second cover member 32, and the second driving motor 33 be integrated into one module, and the two module have the same external appearance.

A method of controlling the appearance and disappearance of the camera module for a vehicle according to an embodiment of the present invention is described below with reference to FIG. 6.

When a driver turns the startup key of the vehicle or turns on a power source as shown, the battery power source of the vehicle is switched from an off state to an on state, so that the power source may be supplied to the various parts of the vehicle at step S10.

When the power source starts being supplied at step S10, the control unit 50 determines whether the front and rear camera modules 21 and 31 have started operating at step S20.

If, as a result of the determination, it is determined that the front and rear camera modules 21 and 31 have started operating at step S20, the control unit 50 determines whether the front and rear camera modules 21 and 31 have popped up at step S30. If, as a result of the determination, it is determined that the front and rear camera modules 21 and 31 have not popped up, the control unit 50 forward rotates the first and the second driving motors 23 and 33 at step S40 and pop the front and rear camera modules 21 and 31 at step S50.

If, as a result of the determination at step S30, it is determined that the front and rear camera modules 21 and 31 have already popped up, the control unit 50 determines whether the front and rear camera modules 21 and 31 are operating at step S60. If, as a result of the determination, it is determined that the front and rear camera modules 21 and 31 are operating, the control unit 50 maintains the operating state. If, as a result of the determination at step S60, it is determined that the front and rear camera modules 21 and 31 are not operating (i.e., an off state), the control unit 50 backward rotates the first and the second driving motors 23 and 33 at step S70 and receives the front and rear camera modules 21 and 31 at step S80.

The embodiments of the present invention described above and shown in the drawings should not be construed as limiting the technical spirit of the present invention. The scope of the present invention is restricted by only the claims, and a person having ordinary skill in the art to which the present invention pertains may improve and modify the technical spirit of the present invention in various forms. Accordingly, the modifications and modifications will fall within the scope of the present invention as long as they are evident to those skilled in the art.

### INDUSTRIAL APPLICABILITY

The pop-up type camera unit of the present invention may be used as a camera module for monitoring the front and rear of a vehicle.

1. A pop-up type camera unit for a vehicle, comprising:
a camera module;
a cover member installed in a rear of the camera module and configured to protect the camera module;
a driving motor configured to have one end coupled to the cover member and to rotate the cover member while operating in conjunction with forward rotation and backward rotation operations; and
a control unit configured to detect a power source supplied to the camera module, forward rotate the driving motor so that the camera module pops up when the power source supplied to the camera module is turned on, and backward rotates the driving motor so that the camera module is hidden when the power source supplied to the camera module is turned off,
wherein the pop-up type camera unit is installed at least one of a front grill and a rear garnish of the vehicle.

2. The pop-up type camera unit of claim 1, wherein:
the cover member comprises a rotary movement hinge at an end one side thereof, and
the driving motor forward rotates and backward rotates the cover member by rotating the rotary movement hinge.

3. The pop-up type camera unit of claim 2, wherein the driving motor is directly coupled to the rotary movement hinge.

4. The pop-up type camera unit of claim 2, wherein the driving motor is indirectly coupled to the rotary movement hinge through a power transfer unit.

5. A method of controlling an appearance and disappearance of a camera module for a vehicle, the method comprising the steps of:
turning on a battery power source;
a control unit determining whether the camera module is operated by detecting a power source supplied to the camera module;
determining whether the camera module has popped up if it is determined that the camera module is operated;
forward rotating a driving motor so that the camera module is protruded if it is determined that the camera module has not popped up;
determining whether the camera module is operated again if it is determined that the camera module has popped up; and
backward rotating the driving motor so that the camera module is hidden if it is determined that the camera module is not operated.

6. A method of controlling an appearance and disappearance of a camera module for a vehicle, the method comprising the steps of:
turning on a battery power source;
a control unit determining whether the camera module is operated by detecting a power source supplied to the camera module;
determining whether the camera module has popped up if it is determined that the camera module is operated;
forward rotating a driving motor so that the camera module is protruded if it is determined that the camera module has not popped up;
determining whether the camera module is operated again if it is determined that the camera module has popped up; and
backward rotating the driving motor so that the camera module is hidden if it is determined that the camera module is not operated.

7. A pop-up type camera unit for a vehicle, comprising:
a camera module;
a cover member installed in a rear of the camera module and configured to protect the camera module;
a rotary movement hinge installed in the cover member and configured to have the camera module rotated around the rotary movement hinge;
a driving motor configured to have an output axis coupled to the rotary movement hinge and to rotate the cover member while operating in conjunction with forward rotation and backward rotation operations of the output axis; and
a control unit configured to detect a power source supplied to the camera module, forward rotate the driving motor so that the camera module pops up when the power source supplied to the camera module is turned on, and backward rotates the driving motor so that the camera module is hidden when the power source supplied to the camera module is turned off,
wherein the pop-up type camera unit is installed at least one of a front grill and a rear garnish of the vehicle.

8. The pop-up type camera unit of claim 7, wherein the driving motor forward rotates and backward rotates the cover member by rotating the rotary movement hinge.

9. The pop-up type camera unit of claim 8, wherein the driving motor is directly coupled to the rotary movement hinge.

10. The pop-up type camera unit of claim 8, wherein the driving motor is indirectly coupled to the rotary movement hinge through a power transfer unit.

11. The pop-up type camera unit of claim 8, wherein the camera module, the cover member, and the driving motor are formed into one module.

12. A pop-up type camera unit for a vehicle, comprising:
a camera module;
a cover member installed in a rear of the camera module and configured to protect the camera module;
a rotary movement hinge installed in the cover member and configured to have the camera module rotated around the rotary movement hinge;
a driving motor configured to have one end coupled to the rotary movement hinge and to rotate the cover member while operating in conjunction with forward rotation and backward rotation operations; and
a control unit configured to detect a power source supplied to the camera module, forward rotate the driving motor so that the camera module pops up when the power source supplied to the camera module is turned on, and backward rotates the driving motor so that the camera module is hidden when the power source supplied to the camera module is turned off,
wherein the pop-up type camera unit is installed at least one of a front grill and a rear garnish of the vehicle.

13. The pop-up type camera unit of claim 12, wherein the driving motor is directly coupled to the rotary movement hinge.

14. The pop-up type camera unit of claim 12, wherein the driving motor is indirectly coupled to the rotary movement hinge through a power transfer unit.

15. The pop-up type camera unit of claim 12, wherein the camera module, the cover member, and the driving motor are integrally configured.
